(19) United States
(12) Patent Application Publication
(10) Pub. No.: US 2026/0365258 A1
(43) Pub. Date: Nov. 19, 2026

(54) COMMERCIAL OR TRANSPORT VEHICLE PARTITION WALL

(71) Applicant: Sortimo International GmbH, Zusmarshausen (DE)

(72) Inventor: Reinhold BRAUN, Zusmarshausen (DE)

(21) Appl. No.: 19/726,417

(22) Filed: Jun. 30, 2026

(30) Foreign Application Priority Data
May 6, 2025 (DE) 202025102480.2

(51) Int. Cl. B62D 33/06; B60R 11/00; B62D 29/02; B62D 29/04; B62D 33/04

(52) U.S. Cl. CPC B62D 33/06; B60R 11/00; B62D 29/02; B62D 29/043; B62D 33/042; B60R 2011/0003

(57) ABSTRACT

A partition wall for commercial or transport vehicles that enables simple and cost-effective separation between the cargo area and the driver's cab for a wide variety of different commercial or transport vehicle types. In one embodiment the partition wall has a thermoformed shell-shaped plastic inner part and a surrounding outer part made of wood (e.g., solid wood, laminated wood, fiberboard, composite wood, particleboard, TPO core, solid core, or the like) and configured for attaching the partition wall to the commercial or transport vehicle. The partition wall therefore includes a universal inner part that can be used with all vehicle types and a surrounding outer part that can be manufactured cost-effectively and adapted easily to interface with different vehicle types having different interior configurations.

### CROSS-REFERENCE TO RELATED APPLICATION

This application claims the benefit under 35 U.S.C. § 119 of German Patent Application Serial No. 20 2025 102 480.2, filed on May 6, 2025, the entire contents of which are hereby incorporated by reference as if fully set forth.

### BACKGROUND

Partition walls are used in commercial or transport vehicles to separate a cargo area from the driver's cab. These partition walls protect the driver and prevent unsecured items stored in the cargo area from entering the driver's cab when the vehicle decelerates. Partition walls thus offer protection for both the driver and the material located in the cargo area. Furthermore, partition walls can dampen noises originating from the cargo area, thereby providing sound insulation for the driver's cab.

### BRIEF DESCRIPTION OF DRAWINGS

Various embodiments in accordance with the present disclosure will be described with reference to the drawings, in which:

FIG. 1 is a front perspective view illustrating part of a commercial or transport vehicle including two B-pillars and a partition wall to separate a cargo area from a driver's cab according to some embodiments;

FIG. 2 is a rear perspective view illustrating the B-pillars and the partition wall of FIG. 1 and a floor panel of the commercial or transport vehicle; and

FIG. 3 is an exploded rear perspective view illustrating the B-pillars, the partition wall, and the floor panel of FIGS. 1 and 2.

### DETAILED DESCRIPTION

The present disclosure relates to a partition wall for a commercial or transport vehicle as well as to a commercial or transport vehicle having such a partition wall. Typically, partition walls for commercial or transport vehicles are manufactured from plastic as a single unit using a thermoforming process. This means that a specially designed thermoforming tool must be provided for each type of vehicle. However, due to the large number of different vehicle types, the thermoforming process is costly and involves a correspondingly high storage and material expenditure.

Some of the present embodiments provide a partition wall for commercial or transport vehicles that enables simple and cost-effective separation between the cargo area and the driver's cab for a wide variety of different commercial or transport vehicle types. For example, in some embodiments the partition wall has a thermoformed shell-shaped plastic inner part and a surrounding outer part made of one or more wooden components and connected to the plastic inner part for attaching the partition wall to the commercial or transport vehicle. The partition wall therefore includes an inner part that can be used universally as a standard part for all vehicle types and a surrounding outer part that can be manufactured cost-effectively and adapted easily for different vehicle types. The wooden components used for the surrounding outer part are easy to manufacture and can also be easily processed if necessary, thus adapting to the respective requirements without effort. Only one thermoforming tool is therefore required for the production of partition walls adapted to different vehicle types. The adaptation to the different vehicle types can be achieved relatively easily by exchanging the easily manufactured and easily assembled surrounding outer parts. This means that multiple, complex and expensive thermoforming tools are not required for different vehicle types.

In some embodiments, the shell-shaped plastic inner part has a peripheral angled rim for attaching the surrounding outer part formed from one or more wooden components. This peripheral angled rim allows the surrounding outer part, which may be adapted to the respective interior shapes of different vehicle types, to be mounted relatively quickly and easily to the shell-shaped plastic inner part.

In some embodiments, the surrounding outer part can conveniently include an upper wooden component that can be connected to the plastic inner part and a lower wooden component that can be connected to the plastic inner part. The outer contours of the wooden components are adapted to the inner contours of the respective vehicle types. In some embodiments, the surrounding outer part can also be formed by just one wooden component or by more than two wooden components.

In some embodiments, shell-shaped plastic inner part comprises a plurality of flat triangular and polygonal surface segments. However, it can also have a continuous curved surface.

Depending on the requirements, the shell-shaped plastic inner part can be made of an opaque plastic or a transparent plastic in various embodiments. When using transparent plastic, the plastic inner part can serve as a window in the partition wall.

In some embodiments, the wooden component(s) of the surrounding outer part are expediently designed in a planar shape and their inner contours are adapted to the outer contours of the plastic inner part. This feature makes these components easy to manufacture and easy to assemble. Depending on the design and intended use, these components can also have a different shape. The wooden component(s) of the surrounding outer part can be made of solid wood, laminated wood, fiberboard, composite wood, particleboard, TPO (thermoplastic polyolefin) core, solid core, or the like in various embodiments.

In some embodiments, an elongate retaining rail for holding objects is arranged in a groove-shaped recess on a rear side of the plastic inner part of the partition wall. This rail allows items such as tool bags, tools, accessories, or other objects to be securely held on the partition wall.

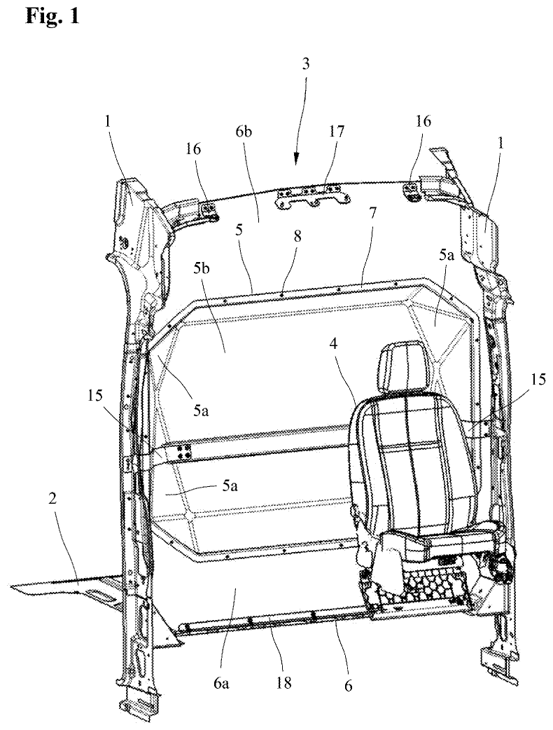

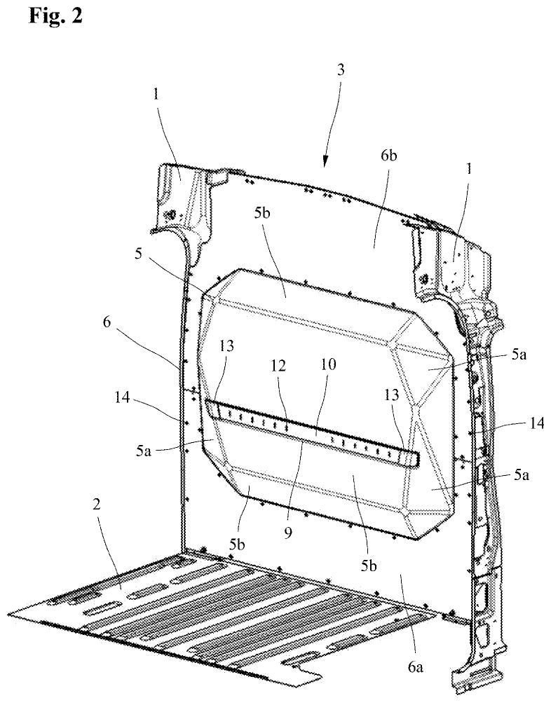

FIGS. 1 and 2 show a part of a commercial or transport vehicle with two B-pillars 1, a vehicle floor 2, and a commercial or transport vehicle partition wall 3 arranged between the two B-pillars 1 to separate a cargo area from a driver's cab. FIG. 1 also shows a driver's seat 4 arranged in front of the partition wall 3.

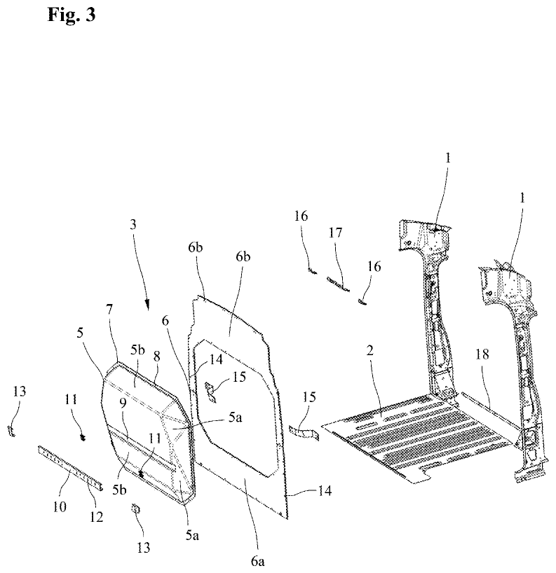

In the embodiment shown in the exploded view of FIG. 3, the partition wall 3 has a thermoformed, shell-shaped plastic inner part 5 and a surrounding outer part 6 connected to the plastic inner part 5 and made of a plurality of planar wooden components 6a, 6b. The shell-shaped plastic inner part 5, which may be manufactured from plastic using a thermoforming process, projects toward the cargo area located above the vehicle floor 2 and, in the embodiment shown, includes a plurality of triangular or polygonal surface segments 5a and 5b. In various embodiments, the shell-shaped plastic inner part 5 can be made of an opaque plastic, such as acrylonitrile butadiene styrene (ABS), or a transparent plastic, such as polycarbonate (PC).

The shell-shaped plastic inner part 5 has a peripheral rim 7, also visible in FIG. 1, for attaching the wooden components 6a, 6b that form the surrounding outer part 6. Holes 8 for fastening the wooden components 6a, 6b can be arranged in the angled rim 7. In the illustrated embodiment, on the rear of the plastic inner part 5, the rear being the side facing the cargo area, there is a groove-shaped recess 9 in which an elongate retaining rail 10 for holding tool bags, tools, accessories, or other objects is attached via fastening elements 11 visible in FIG. 3.

In the embodiment shown in FIG. 2, the retaining rail 10 contains a plurality of retaining slots 12 extending at right angles to its longitudinal direction and spaced apart from each other in the longitudinal direction of the retaining rail 10, and into which tool bags, tools, or other accessories can be hung via hook-shaped holders and held securely. End caps 13, which may be made of plastic, for example, are arranged at the ends of the retaining rail 10.

In the illustrated embodiment, the surrounding outer part 6 includes a lower planar wooden component 6a and an upper planar wooden component 6b. The outer contour of the two planar wooden components 6a, 6b is adapted to the inner contour of the respective commercial or transport vehicle. The two planar wooden components 6a, 6b are designed in the form of a half-frame and enclose the shell-shaped plastic inner part 5. The partition wall 3 can be attached to the two B-pillars 1 via the surrounding outer part 6 formed by the planar wooden components 6a, 6b. Recesses and outer contours can be provided on the perimeter of the planar wooden components 6a, 6b as required for installation in the vehicle interior, and these recesses and outer contours can vary to match the geometry of the vehicle type into which the partition wall 3 is to be installed. In the embodiment shown, the dividing line between the two planar wooden components 6a, 6b runs horizontally. In alternative embodiments, the dividing line could also run vertically, so that two identically designed wooden components are sufficient to form the surrounding outer part 6. The surrounding outer part 6 could also be formed by more than two wooden components or by a single planar component with a corresponding opening to accommodate the plastic inner part 5.

In the embodiment shown in FIGS. 1-3, the partition wall 3 can be attached to the two B-pillars 1 via holes 14 on the outside of the wooden components 6a, 6b and suitable fastening elements, such as screws or rivets. On the front of the shell-shaped plastic inner part 5, the front being the side facing the driver's cab, angled brackets 15 are provided, visible in FIGS. 1 and 3, for supporting the plastic inner part 5 against the B-pillars 1. The retaining rail 10 can also be attached to the angled brackets 15 in some embodiments. Additional mounting brackets 16, 17, visible in FIGS. 1 and 3, may be attached to the upper side of the front of the surrounding outer part 6. A strip-shaped retaining element 18 may also be attached to the underside of the surrounding outer part 6.

In the preceding description, various embodiments are described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

References to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean any of A, B, or C, or any combination thereof (e.g., A, B, and/or C). Similarly, language such as “at least one or more of A, B, and C” (or “one or more of A, B, and C”) is intended to be understood to mean any of A, B, or C, or any combination thereof (e.g., A, B, and/or C). As such, disjunctive language is not intended to, nor should it be understood to, imply that a given embodiment requires at least one of A, at least one of B, and at least one of C to each be present.

As used herein, the term “based on” (or similar) is an open-ended term used to describe one or more factors that affect a determination or other action. This term does not foreclose additional factors that may affect a determination or action. For example, a determination may be solely based on the factor(s) listed or based on the factor(s) and one or more additional factors. Thus, if an action A is “based on” B, then B is one factor that affects action A, but this does not foreclose the action A from also being based on one or more other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (meaning having the potential to), rather than the mandatory sense (meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A partition wall configured for an interior of a commercial or transport vehicle, the partition wall comprising:
a thermoformed shell-shaped plastic inner part; and
a surrounding outer part connected to the plastic inner part, the surrounding outer part comprising one or more wooden components configured for attaching the partition wall to the commercial or transport vehicle.

2. The commercial or transport vehicle partition wall of claim 1, the shell-shaped plastic inner part including a peripheral angled rim configured for attaching to the surrounding outer part.

3. The commercial or transport vehicle partition wall of claim 1, the surrounding outer part including an upper wooden component connected to the plastic inner part and a lower wooden component connected to the plastic inner part.

4. The commercial or transport vehicle partition wall of claim 1, the shell-shaped plastic inner part comprising a plurality of flat triangular and polygonal surface segments.

5. The commercial or transport vehicle partition wall of claim 1, the shell-shaped plastic inner part comprising an opaque plastic or a transparent plastic.

6. The commercial or transport vehicle partition wall of claim 1, the surrounding outer part having a planar shape.

7. The commercial or transport vehicle partition wall of claim 1, the surrounding outer part comprising solid wood, laminated wood, fiberboard, composite wood, or particleboard.

8. The commercial or transport vehicle partition wall of claim 1, further comprising an elongate retaining rail configured for holding objects arranged in a groove-shaped recess on a rear side of the plastic inner part.

9. The commercial or transport vehicle partition wall of claim 8, the retaining rail containing a plurality of retaining slots extending at right angles to a longitudinal direction of the retaining rail and spaced apart from each other in the longitudinal direction of the retaining rail.

10. The commercial or transport vehicle partition wall of claim 1, further comprising angled brackets arranged on a front side of the shell-shaped plastic inner part.

11. The commercial or transport vehicle partition wall of claim 1, further comprising mounting brackets and/or retaining elements arranged on a front side of the surrounding outer part.

12. A partition wall configured for an interior of a commercial or transport vehicle, the partition wall comprising:
a plastic inner part;
a surrounding outer part connected to the plastic inner part, the surrounding outer part having a planar shape and comprising one or more wooden components configured for attaching the partition wall to the commercial or transport vehicle; and
an elongate retaining rail configured for holding objects arranged in a groove-shaped recess on a rear side of the plastic inner part, the retaining rail containing a plurality of retaining slots extending at right angles to a longitudinal direction of the retaining rail and spaced apart from each other in the longitudinal direction of the retaining rail.

13. The commercial or transport vehicle partition wall of claim 12, further comprising angled brackets arranged on a front side of the plastic inner part.

14. The commercial or transport vehicle partition wall of claim 12, further comprising mounting brackets and/or retaining elements arranged on a front side of the surrounding outer part.

15. A commercial or transport vehicle comprising a partition wall, the partition wall comprising:
a thermoformed shell-shaped plastic inner part; and
a surrounding outer part connected to the plastic inner part, the surrounding outer part comprising one or more wooden components configured for attaching the partition wall to the commercial or transport vehicle.
